(19) United States
(12) Patent Application Publication
(10) Pub. No.: US 2015/0135926 A1
(43) Pub. Date: May 21, 2015

(54) CUTTING BLADE

(71) Applicant: Weber Maschinenbau GmbH Breidenbach, Breidenbach (DE)

(72) Inventors: Guenther Weber, Gross Nemerow (DE); Gerd Lischinski, Schoenbeck (DE); Carsten Reinsch, Chemnitz (DE); Steffen Martens, Trollenhagen (DE); Ulrich Pasel, Wulkenzin (DE)

(73) Assignee: Weber Maschinenbau GmbH Breidenbach, Breidenbach (DE)

(21) Appl. No.: 14/391,653

(22) PCT Filed: Apr. 5, 2013
(86) PCT No.: PCT/EP2013/001020

§ 371 Date: Oct. 9, 2014

(30) Foreign Application Priority Data
Apr. 11, 2012 (DE) 10 2012 007 250.3

(51) Int. Cl. B26D 1/00; B26D 1/28

(52) U.S. Cl. CPC B26D 1/0006; B26D 1/28; B26D 2001/006
USPC 83/672; 83/676

(57) ABSTRACT

The disclosure relates to a cutting blade that is rotatably drivable and provided for machines for slicing food products, in particular high-speed slicers. With the aid of a mounting area surrounding a rotary shaft, the cutting blade is fixed to a drive shaft of the machine. A distance area is provided outside the mounting area but inside the cutting edge area. The disclosure aims at improving the cutting blade with respect to its stability and configuring it such that it has the lowest possible weight. For this purpose, alternately recessed and raised formations are provided in the distance area.

### CROSS-REFERENCE TO RELATED APPLICATIONS

This National Phase application claims priority to German patent application number 10 2012 007 250.3 filed Apr. 11, 2012, and WIPO application number PCT/EP2013/001020 filed Apr. 5, 2013, which are hereby incorporated by reference in their entireties.

### TECHNICAL FIELD

The present disclosure relates to a rotatably drivable cutting blade for machines for slicing food products, in particular high-speed slicers, said cutting blade being fixed to a drive shaft with the aid of a mounting area, which surrounds a rotary shaft, and having a preferably flat distance area outside the mounting area and inside a cutting edge area.

### BACKGROUND

A cutting blade of this type is known from DE 10 2009 006 912. The circular cutting blade includes, in the area of the cutting edge, raised portions which are provided for reducing the friction between the blade surface and the food slices. The raised portions are configured as dome-shaped ribs or as ribs having the shape of a spherical segment. The cut-off food slice is intended to contact only the crests of the ribs during the cutting process, whereby the friction between the food product and the blade is reduced. To this end, the raised portions are located directly adjacent to the cutting edge.

Blades of the above-mentioned type rotate with a rotary speed of at least 1,500 revolutions per minute and, for producing perfectly cut products, they should be as stiff as possible and optimally balanced. In the case of the known blade, the raised portions are held by means of plug-like fastening sections that are anchored in the blade. This does not result in a substantial stiffening of the blade, although the raised portions reinforce the blade at least in the area of the cutting edge.

### SUMMARY

It is the object of the present disclosure to increase the stiffness and minimize the weight of cutting blades of the type referred to at the beginning and to accomplish a good cutting quality.

According to the present disclosure, this object is achieved in that embossed, alternately recessed and raised formations are provided in the distance area. Due to the embossing of formations within the distance area, the microstructure is hardened and this imparts, together with the shape of the formation, an increased stiffness to the cutting blade. The formations are located within the distance area of the cutting blade, i.e. outside of the cutting edge area, and consequently they can be formed such that they will contact neither the food product nor the slices to be severed therefrom. Depending on their shape, the formations may also serve to produce preferably local air vortices at the rotating blade so as to reduce the deflection of cut-off food slices in this way. Since such cutting blades have to be balanced statically and dynamically, the formations can also be used for optimizing balancing. Due to the alternate forming, a dynamic unbalance is almost avoided. At the same time, a reduction of wobbling is achieved.

Last but not least, the hardening of the microstructure accomplished by said embossing can contribute to a substantial reduction of weight of the cutting blade, since an increase in the stiffness of the blade allows a reduction of the thickness of the material.

According to a preferred embodiment, the embossed formations have a material thickness corresponding at most to that of the surrounding areas of the distance area. The embossing of the formations allows also a reduction of the thickness of the material. This applies especially to cases in which the formations are produced by deep drawing.

As regards the shape of the formations, a great variety of shapes can be chosen. If the dimple effect known from golf balls is to be achieved for the cutting blade, the formations may be circular in shape. If the formations are to be configured with an elongate shape, depressions will be advisable. These depressions may have a flat bottom so as to avoid sharp bends, edges or breaks.

These formations may be oriented in the radial direction, whereby the above mentioned radial flow of air will be supported.

In this context, the formations may be formed as elongate depressions, grooves or ribs extending in the radial direction. The radial orientation increases the stiffness against bending.

It is also possible to arrange a plurality of formations one after the other in the radial direction. The width of said formations on their radial outer end may exceed that on the inner end. The formations are thus wedge-shaped to a certain extent.

In this context, it may also be advantageous to configure the formations such that they increase in depth in the radial direction, whereby the radial flow of air is supported and a desired turbulence flow may be produced.

The formations may be provided alternately in the direction of the inner and outer side of the blade across the circumference, so that—when seen in the circumferential direction—a mountain-valley pattern is obtained. In principle, it is imaginable that the flat distance area is thus subdivided to a certain extent in that the alternating formations merge with one another and form a wave pattern in the circumferential direction. It is precisely this wave pattern that provides a very high stiffness of the blade against bending.

In order to obtain the above-mentioned distance between the product being cut on the one hand and the blade on the other, the cutting edge area should include an angle (α) relative to the plane of the distance area.

The present disclosure can be used not only for a circular blade but also for an involute blade. The formations may optionally be used systematically for dynamic balancing.

DE 10 2007 026 321 discloses a cutting machine blade, in particular a cutter blade, in the case of which recesses and/or projections are successively provided in the radial direction. They are not located in the cutting edge area but immediately behind said area so as to come into contact with the cut product. The recesses and projections are therefore intended to improve the size-reducing performance, to increase protein breakdown and to accomplish a more intensive emulsification of the product being cut. In addition, the recesses and/or projections are provided for accomplishing an improved swirl in the sausage meat. Hence, the recesses and/or projections serve, analogously to DE 10 2009 006 912, the purpose of contacting the product being cut, an effect which is not intended to be produced according to the present disclosure.

In the following, embodiments of the present disclosure are described making reference to the drawings, in which:

### BRIEF DESCRIPTION OF THE DRAWINGS

FIG. 1 shows the top view of an involute blade according to the present disclosure,

FIG. 2 shows in a perspective detail view a sector of the involute blade according to FIG. 1,

FIG. 3 shows a top view of a further embodiment of an involute blade according to the present disclosure,

FIG. 4 shows a detail view of a sector of the cutting blade according to FIG. 3,

FIG. 5 shows a top view of a third embodiment of a cutting blade according to the present disclosure, and

FIG. 6 shows a detail view of a sector of the cutting blade according to FIG. 5.

### DETAILED DESCRIPTION

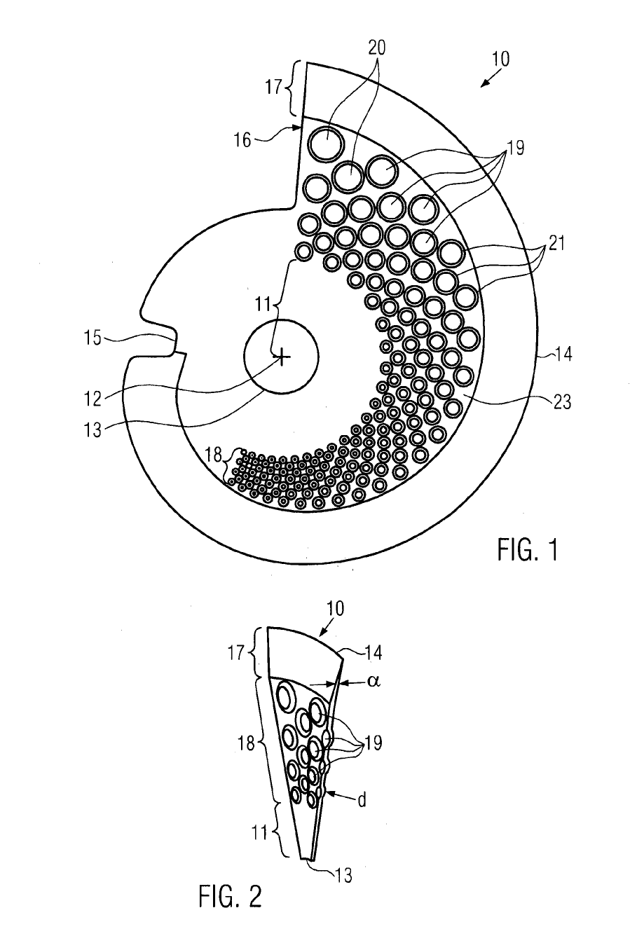

The cutting blade 10 shown in FIG. 1 is provided for machines for slicing food products, in particular for high-speed slicers, said machines being not shown. It comprises a mounting area 11, which surrounds a rotary shaft 12, the latter extending centrally through a circular hole 13.

With the aid of the mounting area 11, the cutting blade 10 is secured to a drive shaft, which is not shown, on end thereof. In the present case, it is configured as an involute blade, and its features correspond to those of DE 10 2007 040 350. This reference originated from the same applicant and the disclosed content of this reference is herewith explicitly referred to.

Such involute blades have a cutting edge 14, which deviates from a circular shape insofar as it extends outwards in a spiral shape around the rotary shaft 12. The cutting edge starts at an indentation and ends at a radial end edge 16. The cutting edge 14 is flanked by a cutting edge area 17.

A distance area 18 extends between the mounting area 11 and the cutting edge area 17. According to the present disclosure, this distance area 18 is provided with embossed formations 19, which project relative to the plane of the distance area. The embossing is preferably carried out by deep drawing, whereby the microstructure of the formations is hardened and the formations have a slightly smaller material thickness d than the surrounding non-embossed distance area 18.

The formations are circular, the diameters of the circles decreasing in the direction of the rotary shaft 12.

The formations alternately project in the direction of the inner and outer cutting blade sides, so that—figuratively speaking—alternate mountains and valleys are formed. In the present case, the formations have flat bottoms, it is, however, also imaginable to configure the bottom such that it is not flat, but e.g. round-bodied.

As shown, the formations can be arranged successively in the radial direction, “mountains” and “valleys” being also formed in alternate succession in said radial direction. The same applies to the circumferential direction, as can e.g. be seen from the sector shown as a detail in FIG. 2.

The embossing of the depressions leads not only to a high stiffness of the cutting blade in its entirety but also to a hardening of the microstructure within the deformations. This will also reduce wobbling of the cutting blade. By embossing the depressions alternately inwards and outwards also the dynamic balancing of the cutting blade is guaranteed.

The formations are provided with flutes 21 defining the respective transition to the plane of the distance area 18 and the bottom 20, respectively. These flutes may become smaller and shallower towards the rotary shaft so as to provide the same stiffness from the center of the cutting blade to the cutting edge.

The circular formations are able to accomplish a flow effect corresponding to that produced by the depressions (dimples) of a golf ball. The secondary angle leads to a reduction of air friction. Air vortices cause a reduction in the deflection of interleavers used in the portioning operation. The same applies to the deposition of the slices.

The turbulence flow of air layers leads to the formation of an advantageous flow.

The embossing of the formations makes the cutting blade much stiffer, whereby the material thickness and the weight of the blade can be reduced. The same applies to the counterweight.

Last but not least, the formations may also be used for dynamically balancing the cutting blade. To this end, the depth and also the structural design of the formations may be varied during the embossing process.

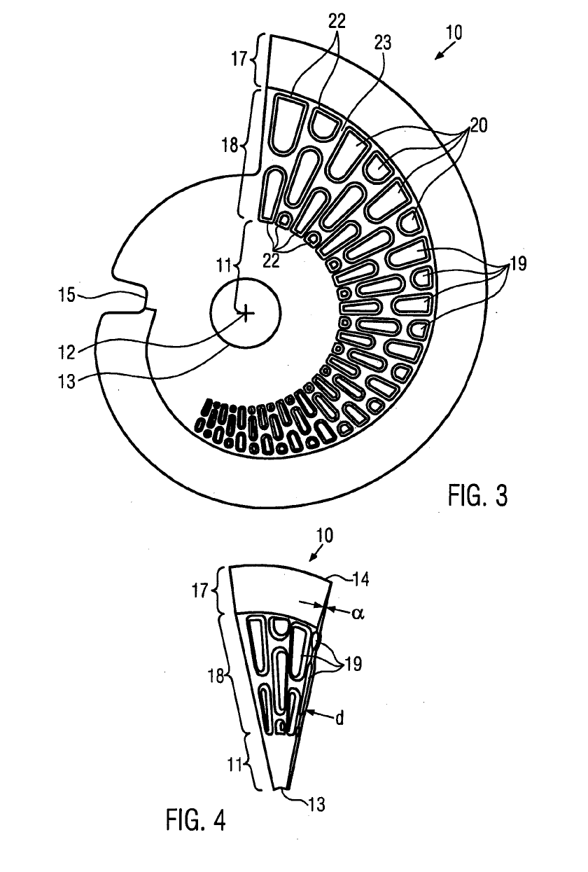

The embodiments of FIGS. 3 to 6 correspond substantially to the embodiment according to FIGS. 1 and 2. In order to avoid repetitions, like reference numerals are used for like designations. Only the differences will be discussed in more detail.

Also FIG. 3 shows a top view of an involute blade. Other than in the case of the embodiments according to FIGS. 1 and 2, the formations 19 are not circular, but they are elongate depressions that extend in the radial direction. The depressions have a flat bottom, they may, however, also be round-bodied. The bulge may then extend in the direction of the inner as well as in the direction of the outer side of the blade.

The formations project alternately in the direction of the inner and the outer sides of the blade. They are arranged successively in the radial direction. Respective inwardly and outwardly projecting formations alternate not only in the radial direction but also in the circumferential direction.

The embossed pattern recurs from the end edge 16 in the circumferential direction towards the indentation 15, the dimensions becoming increasingly smaller analogously to the hole pattern of FIG. 1. Hence, the formations are largest in size in the vicinity of the end edge 16 and smallest in size at the other end. Likewise, the width of the respective formations is larger on their radial outer end than on their radial inner end.

In addition, in the embodiment according to FIG. 3, formations located adjacent to the mounting area 11 and the cutting edge area 17, respectively, have a straight end edge 22.

The formations 19 also increase in depth in the radial direction, the depth being limited by the circumstance that a contact between the respective formation and the product being cut should be avoided during the cutting operation.

The cutting edge area 17 defines an angle α with the plane of the distance area 18.

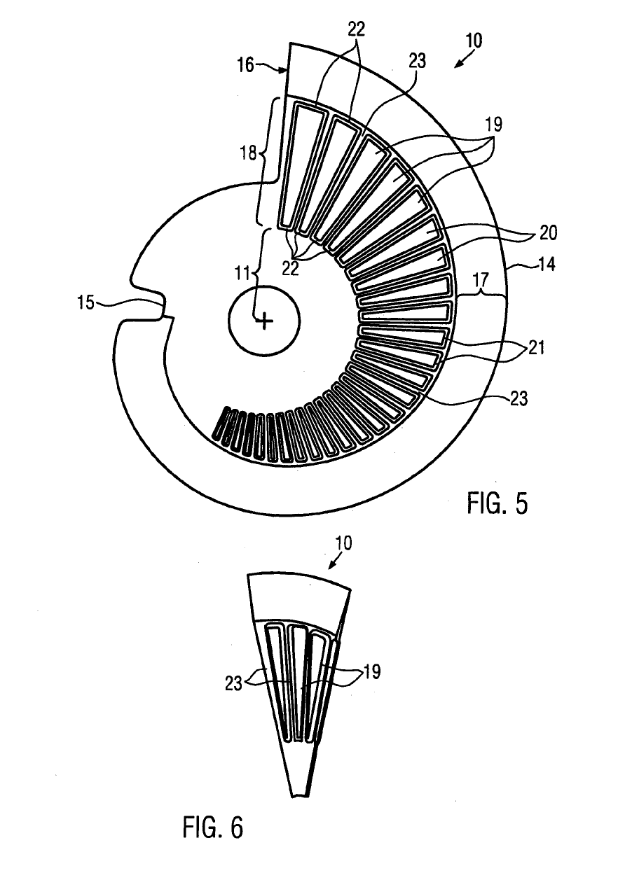

FIGS. 5 and 6 show a further embodiment of the present disclosure. The formations 19 extend here continuously from the cutting edge area 17 to the mounting area 11. They are formed as radial, elongate, continuous depressions. They project relative to the plane of the distance area and, in the circumferential direction, formations projecting in the direction of the inner side alternate with those projecting in the direction of the outer side, so that a mountain-valley shape is again obtained in the circumferential direction. Precisely in the case of this embodiment, it is imaginable to configure the mountain and valley formations such that a wave formation is obtained, in the case of which the flat pieces 23 of the distance area, which are still visible in FIG. 5, disappear.

The formations 19 of this embodiment have straight end edges 22 at their respective radial inner and radial outer ends.

1. A rotatably drivable cutting blade for machines for slicing food products, in particular high-speed slicers, said cutting blade being fixed to a drive shaft with the aid of a mounting area, which surrounds a rotary shaft, and having a preferably flat distance area outside the mounting area and inside a cutting edge area, wherein embossed, alternately recessed and raised formations are provided in the distance area.

2. The cutting blade according to claim 1, wherein the embossed formations have a material thickness corresponding at most to that of the surrounding areas of the distance area.

3. The cutting blade according to claim 1, wherein the formations are circular.

4. The cutting blade according to claim 1, wherein the formations are configured as depressions having a preferably flat bottom.

5. The cutting blade according to claim 1, wherein the formations are oriented in the radial direction.

6. The cutting blade according to claim 1, wherein the formations have an elongate shape that extends in the radial direction.

7. The cutting blade according to claim 1, wherein a plurality of formations extend successively in the radial direction.

8. The cutting blade according to claim 1, wherein the formations have on their radial outer end a width that is larger than the width on their inner radial end.

9. The cutting blade according to claim 1, wherein the formations increase in depth in the radial direction.

10. The cutting blade according to claim 1, wherein the formations project alternately in the direction of the inner and outer sides of the blade across the circumference.

11. The cutting blade according to claim 1, wherein the formations following one another in the radial direction project alternately in the direction of the inner and outer sides of the cutting blade.

12. The cutting blade according to claim 1, wherein the formations are formed by deep drawing.

13. The cutting blade according to claim 1, wherein the cutting edge area includes an angle relative to the plane of the distance area.

14. The cutting blade according to claim 1, wherein the cutting blade is an involute blade having on its radially outer circumference a cutting edge that deviates from a circular shape, in particular a cutting edge extending after the fashion of a spiral around the rotary shaft.

15. The cutting blade according to claim 1, wherein the cutting edge is located in a cutting plane that extends perpendicular to the rotary shaft, the cutting edge defining the radially outer end of a cutting surface.
